(19) United States
(12) Patent Application Publication
(10) Pub. No.: US 2012/0038639 A1
(43) Pub. Date: Feb. 16, 2012

(54) PRESENTATION-ENHANCED SOLID MECHANICAL SIMULATION

(76) Inventors: Vincent Mora, Montreal (CA); Di Jiang, Montreal (CA); Rupert Brooks, Montreal (CA); Sébastien Delorme, Saint-Lambert (CA)

(21) Appl. No.: 12/854,336

(22) Filed: Aug. 11, 2010

(51) Int. Cl. G06T 17/00

(52) U.S. Cl. 345/420

(57) ABSTRACT

In a solid mechanics simulation of a deformable object having: a model representing a condition of the deformable object; a rendering module for presenting an image of the object in response to states of the elements of the object according to an oriented view; and a user interface for a user to mechanically interact with the model to deform the modeled object; an enhancement is provided that effectively supplies a refined rendering of the set of elements of the object in view, without adding elements to the model, so that the image is of an object defined locally to a higher degree than that of the model.

### FIELD OF THE INVENTION

The present invention relates in general to interactive simulations of elastic bodies, and in particular, to solid mechanical simulations in which an underlying model of the simulation provides an adequate resolution for global modeling, such as provided by a coarse mesh of modeling elements, wherein rendering is locally enhanced. A user is able to interact with the simulated object anywhere on a surface of the object in a manner that locally deforms the surface to an extent that the deformation exceeds the fineness of the underlying model. The simulation presents the deformation correctly without breaking the integrity and continuity of the model.

### BACKGROUND OF THE INVENTION

Simulation is a technological art. Presenting a model of a system that responds to events in a timely and realistic manner, and updating the model so that subsequent events are also treated in a timely and realistic manner, is a challenge. When response is provided by a visual presentation, a response from the simulation typically needs to be provided at a rate of about 60 Hz at each pixel, to appear realistic. When haptic response is required, the response needs to be as high as 1000 Hz at every haptic point, for modeling of rigid materials. When simulated objects have complex states, and require high fidelity rendering, such as an elastic body having a very high resolution presentation, changes in states of the model as a response to user interaction, are computationally expensive to effect, and system evolution alone can be computationally expensive.

It is known to construct solid mechanical simulations using a variety of methods. Finite Element Method (FEM) is a preferred technique for simulating deformation of objects, and for similar solid mechanics applications. Other modeling methods are known such as Mass Spring Damper, Boundary Element Method, Finite Difference Method, Long Elements Method, Method of Finite Spheres, and chainmail algorithms (e.g. see U.S. Pat. No. 6,839,663 to Temkin et al.). Reduced Order Models of such simulations have also been effectively used to accelerate simulation processing. Some modeling methods limit spreading of displacements throughout the model, simplifying propagation but such simplifications lead to loss of information that may be problematic for complex bodies and interactions, through which many changes are concurrently propagating, and specifically they do not allow for high fidelity modeling of the object. Other modeling methods are applicable to a restricted set of problems with a desired accuracy.

Element-based models compute a displacement field on a mesh of elements representing an object, based on its material properties, as a reaction to an applied mechanical load, as explained by Ayache et al. in U.S. Pat. No. 7,239,992 (who uses a modified FEM approach). The level of detail (resolution) modeled by the simulation is proportional to the mesh granularity. So there is naturally a trade-off between mesh size, and computation times/processor capacity. If the mesh is too coarse, it fails to capture local details like those observed when manipulating soft materials, and if the mesh size is too fine, it is computationally too expensive.

It is known to provide separate surface and volume models. This is particularly useful if there is a fixed delineation of “surfaces”, i.e. aspects of the simulation that are available for interaction, vs. volumes that represent internal structure of the body. Typically a surface mesh includes a triangulated map that provides rudimentary surface structures, to which additional rendering is applied, to give surface texture, illumination and other enhancements that are desired for high fidelity simulations. Thus the volume mesh typically determines a coarse position of the surface of the model, the surface determines orientations and positions of segments (usually triangles) of the surface at a finer resolution, and the rendering provides the completed image. An example of such a simulation structure is taught by Cotin et al. in U.S. Pat. No. 6,714,901. Cotin et al. teaches a 2 part hybrid mesh having fixed positions on the object, a first part being “embedded” in a second. As such, Cotin et al. only provides high resolution mesh (and associated interaction capabilities) at the provisioned part of the simulation. Cotin et al. mentions an internal forces module determines internal forces (for haptic feedback) exerted by the first part on the basis of a deformation law, factoring in auxiliary surface forces dependent on stored, chosen parameters of the object, such as texture, presence of structures and underlying structures. It is further noted that auxiliary surface forces include surface tensions, and that these could be used to amplify a visual effect at display level, such as during an incision. It is clear that Cotin et al. teach a system that provides two separate models and provides an iterative method for marrying the states of the two models near their periphery, and that Cotin et al. is principally concerned with haptic feedback, and not visual rendering. Incisions are topology changing events that are outside of the scope of the present application.

There are many techniques used in rendering to accomplish particular tasks. It is known to retessellate the surface triangulation map to effectively coarsen or refine the surface triangulation map. For example, a vertex iterative method for coarsening (or simplifying) a triangulation is taught in U.S. Pat. No. 5,929,860 to Hoppe. This method simply provides a user with an ability to view a model at various distances. As noted therein, the meshes approximate the model at progressively finer levels of detail. Similarly, U.S. Pat. No. 6,373,489 to Lu et al. teaches rendering images at different resolutions using respective tessellations. Retessellation is again a matter of selecting some subset of the modeled elements and producing a map of those. While a variety of techniques are known for doing so, retessellation to refine a model has distinct limitations. It is only possible to retessellate to within the limits of the fineness of the model, and a computational cost of updating and manipulating a highly refined model is prohibitive. This is why the foregoing applications relate to geological mappings and mappings having fixity to them. A third patent in this kind is U.S. Pat. No. 6,313,837 to Assa et al., which teaches a technique for viewing a fixed model at multiple levels of resolution. Assa et al teach retessellation and consistency checking within the limits of resolution of the model. A grid model is used to facilitate changes in resolution at a uniform rate, and a mesh is used to visualize the model at any given mesh size.

To permit interaction with rendered aspects of simulations, it is known to use a technique called local “refinement”. Basically this entails adding model elements in the region where the simulation is interacted with, and specifying when these model elements are added, precisely how they are affecting each other, and how they affect the neighbouring, preexisting nodes. If there are few constraints to guide the designer on where to populate these additional mesh points, and how to assign attributes to them to minimize effect of the refinement at the outset, provisioned local refinement is impossible, and it is necessary to dynamically refine the model. This can be a computationally expensive process, and can lead to complex algorithms to maintain consistency and integrity of the model, as adding nodes to a model is an act that fundamentally breaks with the integrity of the model. Once the interaction that required a dynamic refinement is completed, in some cases, the additional mesh points will be retained, resulting in an enlarged model requiring more processing at every refresh cycle thereafter. Alternatively the added elements may be removed, which is another instance where the integrity of the model is effectively broken, and a host of processes are required to smooth out the changes in the model.

Thus if a model can be interacted with locally, anywhere on a surface that is relatively large, refinement has its problems. At the same time, without refinement, the surface triangulation typically cannot handle surfaces that can be deformed to a high degree, without the underlying triangulation becoming noticeable, and without losing realism. Consequently, high definition rendering of modeled objects that deform to a high degree under allowable manipulations, may require the addition of numerous additional mesh points, tending toward computational infeasability. A variety of techniques are known to attempt to manage this trade off, such as dynamic progressive meshes (DPM) taught by Wu et al. in Adaptive Nonlinear Finite elements for Deformable Body Simulation Using Dynamic Progressive Meshes, Eurographics 2001, pp, 1-10, vol. 20, No, 3, but as noted in U.S. Pat. No. 7,363,198 to Balaniuk et al., there are significant problems with this solution in terms of resolution. Various adaptive mesh refinement techniques are known having respective advantages and disadvantages, but all involve a fundamentally discontinuous and non-integrated interruption to the normal processing on the model.

In a paper entitled Improving Contact Realism through Event-Based Haptic Feedback to Kuchenbecker et al. (IEEE TRANS. VIS. & COMP. GRAPHICS, VOL. 12, NO. 2, MARCH/APRIL 2006 pp. 219-230), a technique is presented for improving realism of haptic feedback, involving superposition of event-based transients onto a low frequency response. The object modelled is a block of wood.

Applicant has developed a simulation of brain tissue for medical purposes. This application requires modeling of soft substances, high resolution modeling, as well as high accuracy modeling, as the tools interacting with the brain tissue, have small dimension and effect large local deformations. The interaction of the brain with various instruments and the evolution of the physical brain is important for realistic surgical training, augmented visualization during surgical training operations, and for developing new surgical techniques. Surgical instruments have various shapes and mechanics for performing a variety of interactions with biological tissues, such as: indentation, retraction, grasping, pinching, suction/aspiration, cutting, cauterization, fragmentation, perforation, and some of these produce essentially elastic deformations. After a reversible interaction, the tissue recovers its mechanical integrity (e.g. indentation, retraction, grasping, pinching), while irreversible interactions result in a permanent alteration of its mechanics, either by a change in material stiffness (cauterization, perforation), or by a dissection (aspiration, cutting and fragmentation). Some instruments, such as the aspirator, include some reversible and some irreversible changes in different areas of the tissue, and depend on how the device is used. Soft tissue medical applications are one intended field of application for the present invention.

There therefore remains a need for a technique for simulating deformations of a simulated object without increasing complexity of the underlying model, while providing a high fidelity, high quality rendering, especially when substantial deformation of a relatively soft body is simulated.

### SUMMARY OF THE INVENTION

In accordance with the invention, a technique is provided for simulating deformations of simulated object at a higher effective resolution than an underlying model, without increasing complexity of the underlying model. Advantageously a high fidelity, high quality rendering is possible, even when substantial local deformation of a relatively soft body is simulated. The technique may apply only to reversible changes in the interaction between a user and a simulated object, or may apply to all deformations of the object that exceed a visual presentation limit.

According to the invention, an enhancement is applied that effectively renders an image at a higher element definition than the model of the simulated object, providing a realistic deformation. This may be provided by at any processing point between the model update, and the presentation. For example, the enhancement may 1—receive a surface (e.g. triangulation) map of the model in a current view of the simulated object and modify the surface map if it is determined (event-wise or on the basis of the surface map) that the surface map is not suitably detailed, and forward the modified surface map for image rendering; 2—receive a surface map of the elements of the model in a current view of the simulated object, and determine a respective rendering algorithm in dependence on whether the an enhancement is applicable to the corresponding image; or 3—receive a rendered image for the view in the neighborhood where the object was deformed, determine whether the image is suitably detailed (event-based or analytically) and modify the image to add the desired detail to provide a correct view of the deformation. The enhancement may further implicate an interaction module that receives commands and applies commensurate modifications to the simulated object, as the interaction module may determine whether changes call for locally enhanced rendering, and may identify the need for enhancement according to an event, such as a position and/or actuation of a tool. The model may be derived from an element-based method, or a reduced order model thereof, in which case, the view may be associated with a collection of elements of the model, including surface elements and/or volume elements of the model, within a current view. If so, the density of elements of the model may be less than that for which the image is provided, and may be less than a dimension of the deformation or tool with which the body interacts. An important point is that this is accomplished without adding the elements to the model, encumbering each subsequent model update, or requiring the complexity of modifying the model.

In accordance with the invention, a solid mechanics simulation of a deformable object is provided. The simulation comprises: a model representing a condition of the deformable object including a spatial extent of the deformable object, the model producing, in sequential timesteps, respective surface maps of the deformable object; a rendering module for presenting an image of the object to a user given a current condition and surface map of the deformable object relevant to a current oriented view of the object; and a user interface for effectively mechanically interacting with the model, permitting a user to effect deformation of the modeled object with commands. When the object is locally deformed in a region to an extent that exceeds a threshold, a rendering enhancement is applied to locally redefine the image within the region without altering the model. As such, the presented representation is more refined than the model.

The local redefinition may be based on an empirically derived deformation.

The enhancement, when invoked, may effectively supply to a rendering module a surface map according to the view modified in that, in a neighborhood of the location of the object where the interaction was applied, a greater number of elements having a different spatial distribution, and states are provided instead of those in the model. In this case, the rendering module may be identical to the rendering module that receives the surface maps when the enhancement is not invoked.

Alternatively, the enhancement, when invoked, may effectively supply the surface map to an enhanced rendering module for different rendering than provided to the surface map when the enhancement is not invoked. If so, the enhancement may effectively provide an alternative rendering module that takes command signaling input and the set of states of the elements of the object according to the view, and produces a rendering according to the view.

Alternatively, the enhancement, when invoked, may receive an image from a rendering module that produced the image from a surface map, and, if invoked, modify the image in a neighborhood of the location of the object where the interaction was applied to provide additional detail to the image to improve fidelity of the deformation.

The user interface may be coupled to a manual user interface device for providing the commands, which may provide haptic feedback to the user. The user interface device may resemble a handle of an instrument, or may be a whole instrument. An operating part of the instrument may be modeled by the simulation. The instrument may be for indentation, retraction, grasping, pinching, suction/aspiration, cutting, cauterization, fragmentation, or perforation. The object may be a soft mammalian tissue.

The model may comprise a volume model and a surface model. The surface model may output the surface map in the form of a triangulation. The triangulation may be output to the rendering module during normal and/or enhanced processing. The rendering enhancement may comprise an independent model of a local surface of the object in a neighborhood of the deformation; comprise an independent empirically-based model of a local surface of the object in a neighborhood of the deformation; operate contingently, e.g. on a surface map of the model being deemed renderable by a procedure based on the surface map, on a surface map of the model being deemed renderable by a procedure based on a condition of the model, on a surface map of the model being deemed renderable by exogenous simulation input, on a rendered image for presentation on a visual display being deemed smooth, or on an interaction with the model being deemed reversible.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic illustration of a simulation including principal functional components;

FIGS. 2a,b,c,d are flowcharts showing 4 embodiments of enhanced rendering in accordance with embodiments of the invention;

FIGS. 3a,b are images of a calf brain under the action of a surgical aspirator, during a grasping operation, and immediately thereafter, respectively;

FIG. 4 is a representation of three concurrent models used in an example of the invention;

FIG. 5 are images of the simulated surgical aspirator and model of a brain, respectively in rendered, and unrendered forms.

### DESCRIPTION OF PREFERRED EMBODIMENTS

A technique for improving solid mechanical simulation rendering involves an enhancement that effectively renders an image of the simulated object at a higher definition than the model underlying the simulation, to provide a realistic deformation, especially when deformation is effected to an extent that the underlying model is no longer faithful to the action. This may be performed by refining a surface map output by the model to a degree that is more refined than that of the model, or by enhancing the rendering as an alternative or in addition to normal processing. The enhancement may be contingent on identification of reversible changes in the interaction between a user and a simulated object, or other events, for example.

The present invention includes an enhancement to a solid mechanical simulation that transforms a rendered image of a simulated object and/or a surface map of the object, into a higher definition map or image to produce a more realistic rendering of the simulated object than that what was provided by the underlying model. In this manner a computationally feasible solid mechanical model can be used to represent a condition (including spatial extent) of the object without additional model elements (refinement), or topology changes being made, which is especially efficient when a reversible, localized, deformation is made to the simulated object. Advantageously, the refinement of the presented object to a resolution greater than the model (i.e. the enhancement), may implement an empirical, semi-empirical, or physics-based independent model, that may have different degrees of revision, from a relatively cautious interpolation-based refinement, to a separate, local, high-resolution model of a particular region where the deformation is manifested. A first advantage of this approach is that the model refinement, which is very complex and computationally intensive, is avoided, and that the model maintains integrity, fidelity (within its limits of node density) and consistency. Another advantage is that realism may be maintained to any desired degree by running the enhancement in parallel with the simulation, without any disruption, in the event of a deformation that is handled in this manner.

The solid mechanics simulation represents a spatial extent of the object being simulated, and may be produced according to an element-based method, each model element having a position at each timestep of the simulation. A physics-based interaction model is provided for updating each element at each timestep based on the states of each adjacent element, the element's state, and user commands that manipulate a state of the elements such as those at a periphery of the object.

FIG. 1 schematically illustrates a simulation in accordance with an embodiment of the invention. The simulation comprises an element-based model 10 which, will be assumed to be a Finite Element Method (FEM) model, although the variety of physics-based models known in the art are equally applicable, and may be preferred for respective applications. The model 10 is provided by software and hardware of a known variety of kinds, generally including a memory and at least one processor for updating the memory. The model 10 captures a spatial extent of a deformable object. The model 10 includes a mesh of elements, and a physics-based interaction model that consists of equations for locally adjusting the model element states to represent changes in the simulated object throughout evolution of the mesh, in response to interactions, and to propagate these interactions throughout the mesh. The model 10 represents a condition of a simulated deformable object at each timestep, by representing states of a plurality of model elements. The elements influence adjacent elements in dependence on their respective states, to propagate deformations of the object. The model 10 shown consists of a volume model 10a, and a surface model 10b. In some simulations, only a surface of the object may be in view, and in others, a variety of cross-sectional views of the object may be presented, but in all cases the object presented represents a position of elements within a current view (either user-selected, or by default).

One reason for separating the surface and volume models is to provide a different set of constraints for propagation of influence at surfaces in comparison with bulk propagation, and another is the possibility to provide different state information for surface elements than volume elements, to more efficiently update rendering, while permitting the volume to be represented in a manner that is maximally efficient for computing evolution. Naturally the present invention can be provided using a wide range of simulations and the foregoing is specifically preferred for the simulation of soft mammalian tissues, specifically human brains.

The user interface 12 provides commands that permit manipulation of the simulated object, so that the user can mechanically interact with, and deform, the object, and at least see the deformation. The commands may be made by a pre-established procedure, may be provided by manipulation of the object directly, as by a virtual reality glove or a finger tip force controller, or may be provided via an instrument. If the interactions are chiefly provided by pre-established procedures, such as a scripted procedure (initialization procedure, calibration procedure, etc.) the user interface 12 may include conventional hardware such as a keyboard and/or mouse, and may be provided without user input, for example, if the simulated object is to undergo a prescribed procedure with no real-time involvement from a user, who merely observes the simulation in response to the scripted actions. In such embodiments, several advantages of the present invention may not be realized, in that a pre-established model having desired element densities distributed throughout the object will be known beforehand, and thus a suitable model may be provided with a desired degree of local refinement, and can be performed off-line. Nonetheless the advantage of providing an enhanced rendering with a simplified model is provided.

In preferred embodiments, the simulation permits a user to interact with the object in real-time using suitable hardware and software. The instrument may be simulated, in whole or in part (i.e. be represented visually in some views, under some imaging modalities). In some embodiments it may be preferable for an effector end of an instrument be represented, and not a handle of the instrument. The user interface 12 may comprise hardware including an operated part of the instrument, such as a handle, that includes sensors for determining how the instrument is being operated. This may include spatial position and orientation of the instrument in multiple dimensions. In preferred examples, the instrument provides haptic feedback to the user, in which case, the model also computes the reaction force that is transmitted to the user.

The user interface 12 supplies commands that affect the elements in a prescribed manner. For example, the elements may be affected in accordance with a prescribed aspect of the physics-based interaction model associated with the instrument, or other manner in which the object is deformed, and how the instrument is operated or user input is applied.

According to conventional simulation operation, the model 10 (specifically the surface model 1b), creates a surface map (preferably in the form of a triangulated map: i.e. a set of triangles that are connected at each edge and oriented in 3D) that is refreshed at each time step. At least the changes to the triangulated map at each time step (from that of a previous time step) are presented to a rendering module 15 in the normal course of simulation, to render the state changes to the user. This may involve haptic, aural, or other simulated response to the user, but at least includes a visual presentation of the object. The visual presentation may be in the form of an image presented on a display, and may be presented in accordance with a selected oriented and positioned view, at least under one viewing modality. The rendering may also provide haptic, aural, olfactory and/or other feedback. A visual processing component of the rendering module is designed to apply texture, and finishing visual information to the image, in accordance with orientations of the oriented triangles, in a manner known in the art. The enhanced rendering module 15 may have a variety of structures, depending on the embodiment.

In accordance with the invention, an enhancement to this simulation operation is provided, in the form of a module 15 that effectively enhances this rendering process if a change to the elements of the model 10 at a location on the object is provided given commands from the user interface 12. The enhancement effectively supplies a refined rendering of the set of the elements of the object in view, without actually refining the underlying model 10. This may be accomplished by substituting the surface map under prescribed circumstances, or may involve applying a substitute rendering process with embedded information regarding the local deformation effects of the commands, which may be overlaid on the rendering as produced conventionally above, or may substitute a rendered image with a higher definition rendered image. The change in rendering does not alter the model. The model retains fidelity and integrity to within the natural limits of the element density. However the rendering effectively provides additional elements in the surface map (if the map is substituted) or added detail to a rendered image for such reversible or identified operations.

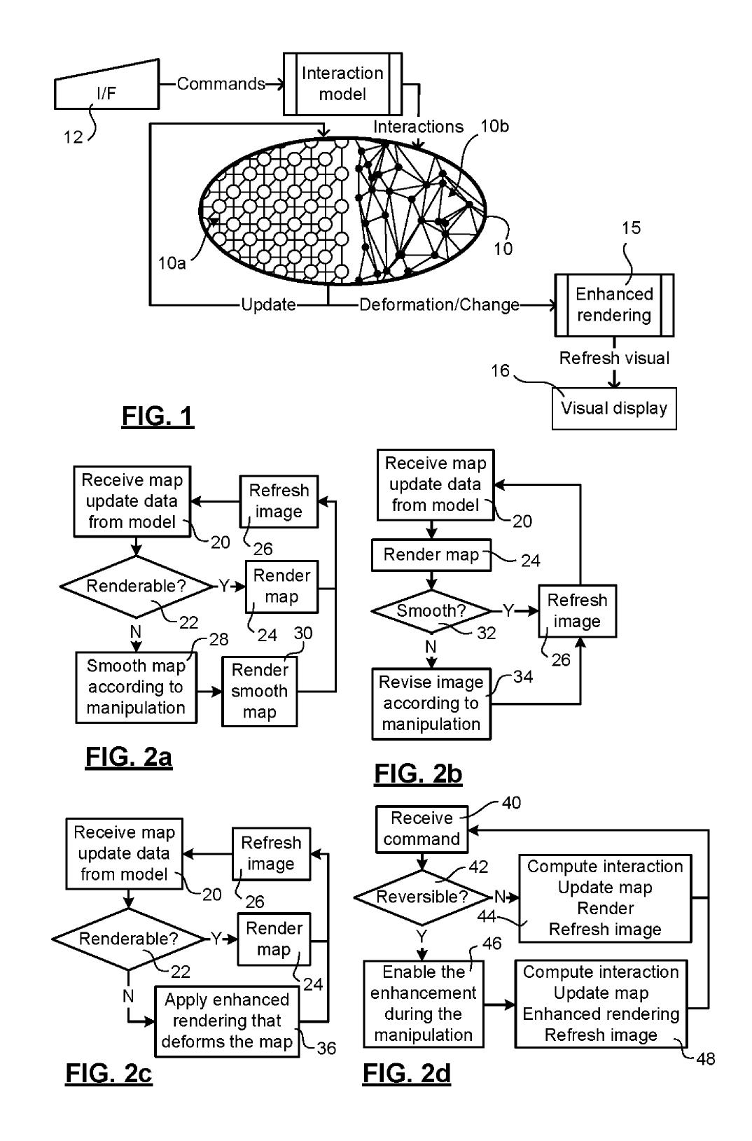

FIGS. 2a,b,c and d are flowcharts schematically illustrating principal steps in the enhancement according to four embodiments of the present invention. In general, the enhancement determines (e.g. from the interaction commands (event-based), an analysis of the surface map or model condition and/or an exogenous simulation input) whether the actions lead to a deformation that is suitably represented with the granularity of the model, or whether enhancement is required. If enhancement is required, at least in some part of the image in view, a higher definition rendering of the model is applied by the enhancement. As will be appreciated, the process of the present invention may be conditional upon, or vary with a mode of operation, a view of the object, or manipulation of the object.

The method of FIG. 2a is performed by enhanced rendering module 15 of FIG. 1 which comprises code for effecting a process between the model 10 a prior art rendering module which effects the imaging. The method is iterated each refresh period, i.e. at least at 60 Hz. As will be appreciated, there may be different refresh periods for different rendering modalities, and for different rendering devices, and the present invention is concerned with the imaging modality or modalities, which provides a visual presentation of the object according to one or more oriented views, which may be user selected. In step 20, the enhanced rendering module 15 receives the current model update (surface) map. The map may be received by polling, read-only access to a memory bank updated by the model 10, or may be published by the model 10, for example. The data may consist of change data (delta), representing a displacement of element states from a previous time step, or may provide a new position for each coordinate. The position may be with respect to a nominal position of the element within the mesh, with respect to a fixed coordinate frame of reference of the object, relative to a current field of view of the simulation, or otherwise. Properties of elements other than position may be modeled, including strain, potential energy, velocity, acceleration, as well as any other simulated parameter that may be associated with an appearance of the object (colour, shape, texture, etc.) in the vicinity of the element.

The enhanced rendering module 15 then determines (step 22) whether the surface map is renderable using a prior art rendering module, or the surface map effectively amounts to a deformation that exceeds a predefined, or instantly determined threshold. If the present condition of the object is deemed renderable, the rendering is applied (step 24) in a manner known in the art, the image is refreshed as per the rendering (step 26), and the procedure returns to step 20. If the condition of the model is deemed not renderable to a desired degree of realism (as represented by any one of a plurality of tests, or simplified indicia), an algorithm is applied to smooth the map (step 28). This smoothing may be provided by simple rote segmenting operations (to divide the surface map), assigning new cells of respective orientations and positions so that the redefined map approximates a curve of a standard smooth function, to a prescribed approximation. The selection of the function may be chosen from among a variety of smooth functions, depending on the change data, or another feature of the manipulation mode, view, or local condition of the object. For example, principal curves through point p at which the manipulation is centered may be chosen for the cells. The smoothed map may approximate a minimal surface to a higher degree than the received map, as best mapped to a periphery of the smoothed region of the map. The smooth map is then rendered, in step 30, to produce an image, which is used to refresh the visual display.

The determination in step 22 may be made in dependence on a mode of operation, view (e.g. zoom factor), and/or manipulation of the object. For example, for interaction with a probe of rounded tip, generally incapable of penetrating the object because the object cannot be deformed past an elastic modulus with the device, the deformation may be an inherently elastic deformation, adequately modeled by a coarse grain FEM mesh, and a slightly finer surface FEM mesh, except for rendering artifacts that are associated with a coarseness of the surface FEM mesh. In such a case the probe, force vector applied to the probe, normal of the object at contact with the probe, and characteristics of the material of the object at the contact point, may be used to determine a local deformation surface and properties of the local deformation surface to be adapted to the image according to a periphery of the existing map that is smoothed. Thus in some cases, particular information regarding the manner of manipulation may be leveraged to provide higher realism of the enhancement, without refining the model. In other situations, a more conservative smoothing approach may be provided by interpolation of larger surface cells having prescribed dimensions. While interpolation can smooth the surfaces, and can be guided heuristically by approximating minimal surfaces or other interpolations using neighbouring surfaces, there are natural limits to the accuracy of these methods in that refinement past a certain point, has no content from the model to guide it, and thus provides smoothest surfaces having increasingly less information. While smoothness was chosen in this example as a guiding mechanism, it will be appreciated that fractal surface roughness, or other guiding principles can be applied to guide the map refinement. Naturally, minimal surfaces are preferred to the extent that the surfaces have elasticity, and exhibit a preference for conformation to minimal surfaces.

In accordance with preferred aspects of the invention, the refinement of the map combines a set of empirical equations that represent the tissue response, within an estimated region of refinement, although in other embodiments it may be preferable to determine, for example, a fitting curve before an extent of the refined region is determined. The refined region of the map may be defined by a sphere of influence that is centered at an interaction point, and may correspond to the tip of an instrument, or a contact point with a glove or other interface mechanism. The size of the sphere of influence may depend on a level of accuracy of the FEM model, usually given by the refinement of the mesh (i.e. local distance between mesh nodes).

FIG. 2b schematically illustrates a second embodiment of a process performed by the enhanced rendering module 15, in accordance with the invention. Like reference numerals refer to substantially identical steps, and these are not described again. At step 20 the updated map is received. The map is immediately rendered in step 24, and it is determined (step 32) whether the rendered image has surface cell features that will be obvious to a viewer. If the image is determined to be smooth, the image is refreshed. If not, an enhancement is invoked (step 34) to revise the image, according to a modality of the manipulation. Such enhancement may involve producing an alternative surface cell structure, and applying a revised rendering thereof, or may dispense with the cell structure model entirely. The enhancement may be based on an empirical model, a semi-empirical model, or a physics-based model of local deformations. The revised image is then sent to the visual display 16 (step 26).

FIG. 2c schematically illustrates a third embodiment of a process in accordance with the invention, performed by the enhanced rendering module 15. Like reference numerals refer to substantially identical steps. The third embodiment essentially applies a modification of steps 28 and 30 of FIG. 2a, to permit revision to at least a refined region of the map, without recourse to the rendering module. This may be useful if the surface properties change significantly once the deformation exceeds a given limit. One example of a modified rendering module is to alter rendering internally. Recent graphics rendering cards permit condition-based modification of rendering processes that allow an effective distortion of the simulated object, based on the surface map received. As will be appreciated by those of skill in the art, a pixel shader process receiving the surface map, along with textures and a normal map is typically used to compute a 2D view of the object. The enhancement may be provided by modifying the texture that is mapped to the triangles, effectively deforming the triangles by warping the normal map to correspond with a different triangulation, or may be provided by an interruption to the rendering under certain conditions.

FIG. 2d schematically illustrates a fourth embodiment of a process in accordance with the invention that is provided by the interaction model and enhanced rendering in tandem. In step 40, the interaction model receives a command from user interface 12 to deform the model. This may be via a variety of instruments, and/or under one of various modes of operation. The interaction model then computes interactions to effect the changes to the model 10, and prior to effecting these changes to the elements of the model 10, the interaction model determines whether the effect is reversible (step 42). While reversibility is not the only feature that could be used to determine applicability of the enhancement, it represents an important case where information lost by modeling the interaction only at a coarser scale than the rendering, is effectively nullified, and thus there is nothing lost in the model itself by application of the enhancement.

If the interaction is determined to be irreversible, the interaction is sent to the model 10, which updates the map, renders the map to produce an image, and refreshes the image (step 44), as per conventional simulation processing. If the interaction is determined to be reversible, enhancement is enabled during the manipulation (step 46), and the interaction model forwards interaction input to the model 10, which revises the model, and updates the map, in step 48. The enhanced rendering is applied on the updated map (at least locally) to produce in image as described above, for example, resulting in a rendered image, which is forwarded to refresh the visual display (also in step 48).

### EXAMPLES

Surgical aspirators are one of the most frequently used neurosurgical tools. There is a need for extensive training on neurosurgical simulators for interventions in general and use of aspirators in particular. Surgical aspirators are included in commercial simulators but studies on their mechanical behavior are scarce in the literature and the literature does not provide enough experimental data to develop a model suitable for a simulator. Simulators providing a visually and haptically realistic rendering of surgical aspiration are desirable, especially when provided with low-cost computers, while providing realism.

This instrument has two main functions: (A) aspiration, which is either the non-traumatic removal of blood and fluid or the removal of soft tissue, and (B) tissue holding. There is little published data on mechanical interaction between soft biological tissues and surgical aspirators. Applicant has contributed to this literature in a paper entitled: A Computer Model of Soft Tissue Interaction with a Surgical Aspirator, which was published in Proceedings of the 12th International Conference on Medical Image Computing and Computer Assisted Intervention (MICCAI 2009), [Part I, LNCS 5761, pp. 51-58, London, UK, September 2009], the contents of which are incorporated herein by reference. Specifically, the paper describes an experimental setup for measuring tissue response and results on calf brain and a variety of phantom materials are presented. Tissue resection (cutting) with suction is simulated using a volume sculpting approach, and a simulation of grasping suction is presented, providing an example of the present invention.

In brain surgery, the aspirator can also be used to manipulate and dissect tissues, through a proper control of the vacuum level. Low vacuum levels permit the aspirator tube to grasp the tissues, thus providing a mechanism for deforming the brain without contacting it directly. At higher vacuum levels, pieces of tissue are removed. The inner diameter of an aspirator tube is about 1 mm. Some features of simulating this type of instrument are: that it requires action at a distance; that the activation of the device dictates response; and that position and orientation of the instrument, along with proximity to the surface of the soft tissues are very important. FIGS. 3a,b are images of calf brain while gripping suction was applied by an aspirator, and immediately afterwards. A deformation of the calf brain was used to determine an empirical model of tissue deformation in response to operation of the surgical aspirator.

The deformation of the tissues by suction includes both localized surface changes in the proximity of the aspirator (when near the surface) and larger scale deformations. The local surface changes have a typical shape that is important to render to achieve realism in the simulation. The larger scale displacements and force fields are given by a 3D explicit non-linear finite element (FE) function that depends on the vacuum level and the position and orientation of the aspirator. Such functions are well known in the art, and implementation of the larger scale displacements for a given application are within the ordinary skill of this art. For example, see Taylor, et al. High-speed Nonlinear Finite Element Analysis for Surgical Simulation using Graphics Processing Units, Trans. Med. Imaging 27(5), 650-662 (2008), and Miller, et al. Total Lagrangian Explicit Dynamics Finite Element Algorithm for Computing Soft Tissue Deformation, Com. Numer. Meth. Eng. 23, 121-134 (2007).

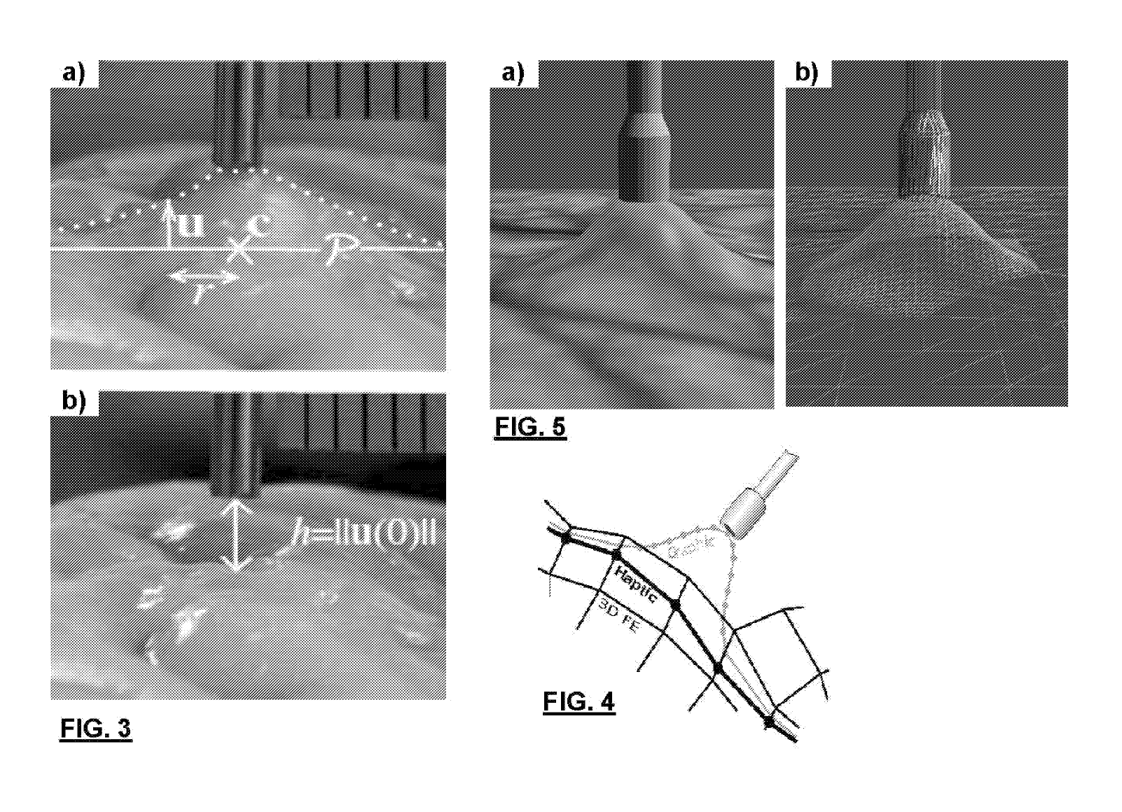

Three different element based models were used in accordance with the invention, generally following the scheme of FIG. 2a. FIG. 4 is a schematic illustration of the simulation, that overlays the model elements, with the enhancement. FIG. 4 shows a segment of a surface model labeled Haptic, a volume model labeled 3D FE underlying the surface model, and a rendered image labeled Graphic. Unlike the surface and volume models that run continuously during a simulation session (and are presented graphically using conventional rendering), the graph curve is produced by the physics-based local model invoked only as required during the simulation. The volume model is updated with the larger scale displacements caused by the aspirator. The surface model is coupled with volume model elements, shown schematically as a path over cells of the volume model elements. When surface nodes of the volume model are sufficiently close to the aspirator tip (depending on the suction pressure), the surface model approaches the rendered image, which is also schematically shown as a piece-wise linear trace having a node density much higher than that of the surface model, in the neighborhood of the aspirator. The 3D FE mesh is used for the deformation calculation. The surface model which is a tesselation of an isosurface of a signed distance field defined on the FE mesh, and is used for collision detection and haptics rendering with the aspirator. The illustrated embodiment was not adapted for multi-instrument applications, but could be adapted to do so if the local model is used for collision detection and haptics rendering with any other device concurrently operated.

The local model is chosen to be a locally refined copy of the surface model. It is never integrated with the surface model, and has a high node density. The local model includes peripheral nodes which are assigned states in accordance with those that correspond with the surface model, however the elements proximal the aspirator tip are assigned states that correspond precisely with an empirically defined profile for the aspirator at the given distance, and with the operating pressure, with no regard for the previous positions (and other state information) of the proximal nodes.

The simulation involves three concurrent loops that run in separate threads: the deformation loop, which updates the volume model, the graphic loop, which renders the images for visual display and encodes the enhancement, and the haptic loop (analogous to known collision detectors). There are several aspects of this embodiment that are outside of the scope of the present invention. The overview of the simulation processes are as follows:

Algorithm 1. Providing haptic and visual feedback

R: cutting radius when suction pressure is sufficient for cutting
F: signed distance field (on levelset)
t: position of tip of the suction tool
G: radius in which haptic vertices interact with suction tools
N: number of grabbed vertices
I: interaction force on surface vertices
Deformation loop:
while simulation is not over

wait for new I;
use I and previous state of volume vertices to update volume vertices;
update surface vertices;

for each suction tool

if pressure of tool is more than cutting pressure of
tissue then

for each vertex x in the volume update
distance field:

F(x) = min( F(x), ∥x−t∥ − R );

end for

end if

end for

compute new surface topology from levelset of F;
end while

Haptic loop:
while simulation is not over

if new surface topology is available then

update haptic surface topology

end if
if updated surface vertices are available then

update haptic surface vertices

end if
for each suction tool

N=0;
for each vertex x in haptic surface

if ∥x−t∥ < G then grab x;
N=N+1;

end for
compute average position P and normal n of vertices
grabbed by this tool;
compute force on instrument: f = −βh²n;
for each grabbed vertex x I(x) = −f/N;
end for

end for
compute collisions with tools;
add collision forces on instruments;
add collision forces to I;

end while

Graphic loop:

while simulation is not over

if new surface topology is available then

update graphic surface topology

end if
if updated surface vertices are available then

update graphic surface vertices

end if
wait for new tool positions;
for each suction tool

refine graphic surface in the vicinity of the tool tip;
for each vertex x in refined graphic surface

move vertex: x = x + h²n/(h+α∥x−P∥³)

end for

end for
render refined graphic surface;

end while

The deformation loop is generally responsible for updating the model. While the simulation is running, the object is initially at rest. Once the object is deformed, a new I (computed by the haptic loop as described below) is received. The deformation loop then applies I as forces to surface elements of the levelset hierarchy (well known in the art). The surface elements then are out of balance with the forces of the adjacent elements of the volume model. By standard iterative finite element modelling processes, the model is updated to provide updated positions of the volume elements, including the surface elements. A provisioned number of iterations of the processing is provided for with the simulation currently used. The surface vertices are thus updated for the next timestep.

In accordance with the simulation, the deformation loop also determines whether the aspirator is operated in a manner to cut the brain, or whether it simply grasps the brain tissue. To enable modeling of tissue cutting while avoiding large changes to the 3D FE mesh, a volume sculpting approach was chosen (see Galyean, et al., Sculpting: an interactive volumetric modeling technique. [Computer Graphics 25(4), 267-274 1991], the contents of which are incorporated herein by reference). The boundaries of soft tissues are modelled as the zero isosurface of a distance field, F(x), defined on the elements of the 3D FE mesh. Tissue removal is modelled by changing the value of F based on the position of the surgical aspirator. A similar approach has been used to simulate cutting of the petrous bone in [Pflesser et al., Volume Cutting for Virtual Petrous Bone Surgery. [Computer Aided Surgery 7(2), 74-83 2002]. Operated at lower pressures, when close enough to the tissue, tissue is attracted and sticks to the tip of the surgical aspirator. This exerts a force on the tissue, and may be used to hold, or manipulate it. The appearance of this kind of deformation is effected by the graphic loop, but not by the volume model.

If the aspiration force is greater or equal than ∥f∥ᵣᵤₚₜᵤᵣₑ, a spherical cutting region around the tool tip, t, becomes active. Tissue within this sphere is removed. To do this, the distance field is updated according to: F_{new}(x)=min(Fold(x), ∥x−t∥−R), where R is the radius of the cutting sphere. Once this function is changed, it is necessary to tesselate the new zero isosurface. This is done using one of a family of algorithms, which we refer to as marching shapes (see Newman, et al. A Survey of the Marching Cubes Algorithm [Computers and Graphics 30, 854-879 2006]), which tesselate each element given the field values at their vertices. The generated surface consists of triangles, whose vertices lie on the edges of the FE mesh. The most widely known such algorithm is the marching cubes of Lorensen and Cline, from Marching Cubes: A High Resolution 3D Surface Construction Algorithm [Computer Graphics 21(4), 163-169 1987]), but the same approach can be based on other shapes, such as tetrahedra, octahedra, etc. When cutting is taking place, the use of this graphic model gives the appearance that the interior parts of the tissue pops up into the aspiration tool.

The haptic loop is principally responsible for generating I. If the levelset is redefined as a result of cutting, this is updated in the haptic loop. When the new surface vertices are provided for a new timestep by the deformation loop, the new haptic surface vertices, which is one kind of surface map, are provided (i.e. the haptic model is updated). For each suction tool that is initialized, a set of vertices of the updated haptic model interacting with the tool are (re)selected, in dependence on a degree of suction applied by the tool and a present position of the tip t. Generally a small number of elements of the model directly interact with the suction tool. Indirectly these elements propagate the deformation to provide a global effect on the simulated brain. This global effect provides the force feedback felt by a user. The grabbed vertices of the haptic model are then used to compute an average position P and normal n of the haptic model, providing a locus of interaction for the tool with the brain. The locus is a plane having the normal and passing through P. A preliminary tool force is computed proportional to h², where h is a distance between that plane and t, and the force is directed in the negative n direction. This equation fits the empirically observed deformation of the calf brain model. The force is linearly proportional with β, a material parameter that increases with the stiffness of the brain tissue. The preliminary tool force is applied to the grabbed vertices. Each grabbed vertex is assigned a force I(x)=−f/N to evenly divide the feedback force among the grabbed vertices. The force acts in the opposite direction to the feedback force. Collisions between the tools are computed and if collision is detected, the collision forces are added to the force applied to the tools and to I (again using techniques known in the art and not relevant to the present invention). I is then computed by the haptic loop to be applied by the deformation loop and to be applied to the user via a haptic device. The haptic device was a replica of the handle end of a surgical aspirator.

The graphic loop presents on a high resolution monitor an image of the object in accordance with a user selected view. Like the haptic loop, the graphic loop first updates the surface topology and obtains the current surface vertices of the volume model, and this copy becomes the present timestep's graphic surface map. As such the graphic and haptic loops may modify their versions of the surface map independently. Upon receipt of a new tool position, for each suction tool, a vicinity of the tool tip in relation to the surface is determined. If the tool tip is close enough to the brain's surface to cause the brain tissue to locally deform and rise up to meet the tool tip (given the level of suction), a refinement is applied to populate the vicinity with a number of vertices that are initially positioned at points interpolated between the initial mesh of the surface map in the vicinity (i.e. the refined graphic surface). Then each element within the vicinity is moved according to the equation h²n/(h+α∥x−P∥³), where α is a local material parameter. The revised graphic surface map, including the refined graphic surface, is then rendered using known rendering algorithms.

FIGS. 5a,b shows output of the modified Haptic surface triangulation for a given operation of the aspirator, respectively in rendered and unrendered forms. This model shows good agreement with experimental data in FIGS. 3a), and b). In addition to being rendered by the haptic device, the force can be applied to the 3D FE model to calculate a deformation. When ∥f∥ is smaller than the experimentally measured value ∥f∥rupture, tissue will be held by the aspirator. Beyond this critical value, the tissue breaks, and is removed by the aspirator.

Naturally, in comparison with a simulation using local refinement, or otherwise provides a higher element density model, the enhanced model will run faster, and have less code. In comparison with local refinement, the enhancement will be less prone to falling into inconsistency, and more seamlessly transit between high resolution imaging of substantial deformation events, and still gives a high fidelity rendering of the interactions tested.

The local interaction model for a surgical aspirator and brain tissue has been demonstrated to be capable of representing interactions, based on experimental manipulations. It creates a visual surface of the tissue with the bell curve shape as experimentally observed, and computes the suction force required for haptic feedback. The force was applied as a haptic feedback and to the FEM deformable tissue model to allow the whole tissue to deform in reaction to the local interaction. The interaction model computes the tissue deformation up to the limit at which the tissue will detach from the aspirator tube. It can also predict dissection, i.e., when the vacuum level is high enough to overcome the tissue resistance. The dissection itself was computed on the FEM tissue model, and not by the local interaction model. Once the local interaction was finished, the local model disappears and the tissue rendering is provided according to normal rendering of its FEM model, and thus the reversible types of interactions are effectively not locally modelled. Conventional modeling of this type of interaction would require a tissue mesh to be significantly more refined than the diameter of the aspirator tube, which was infeasible given the dimensions of the tissue modeled and the lack of limitations on the locations where the tissue can be affected.

The invention has been described having regard to various embodiments and one example. Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A solid mechanics simulation of a deformable object comprising:
a model representing a condition of the deformable object including a spatial extent of the deformable object, the model producing, in sequential timesteps, respective surface maps of the deformable object;
a rendering module for presenting an image of the object to a user given a current condition and surface map of the deformable object relevant to a current oriented view of the object; and
a user interface for effectively mechanically interacting with the model, permitting a user to effect deformation of the modeled object with commands;
wherein, when the object is locally deformed in a region to an extent that exceeds a threshold, a rendering enhancement is applied to locally redefine the image within the region without altering the model;
whereby the presented representation is more refined than the model.

2. The solid mechanics simulation method of claim 1 wherein the local redefinition is based on an empirically derived deformation.

3. The solid mechanics simulation method of claim 1 wherein the enhancement, when invoked, effectively supplies to a rendering module a surface map according to the view modified in that, in a neighborhood of the location of the object where the interaction was applied, a greater number of triangulation elements having a different spatial distribution, and states are provided instead of the surface map.

4. The solid mechanics simulation method of claim 3 wherein the rendering module is identical to the rendering module that receives the surface maps when the enhancement is not invoked.

5. The solid mechanics simulation method of claim 1 wherein the enhancement, when invoked, effectively supplies the surface map to an enhanced rendering module for different rendering than provided to the surface map when the enhancement is not invoked.

6. The solid mechanics simulation method of claim 1 wherein the enhancement effectively provides an alternative rendering module that takes command signaling input and the set of states of the elements of the object according to the view, and produces a rendering according to the view.

7. The solid mechanics simulation method of claim 1 wherein the enhancement effectively receives an image from a rendering module that produced the image from a surface map, and, if invoked, modifies the image in a neighborhood of the location of the object where the interaction was applied to provide additional detail to the image.

8. The solid mechanics simulation method of claim 1 wherein the user interface is:
coupled to a manual user interface device for providing the commands;
coupled to a haptic user interface device for providing the commands;
coupled to a haptic user interface device for providing the commands, the haptic user interface device resembling a handle of an instrument;
coupled to a haptic user interface device for providing the commands, the haptic user interface device resembling a handle of an instrument, wherein an operating part of the instrument is modeled by the simulation;
coupled to a haptic user interface device for providing the commands, the haptic user interface device resembling a handle of an instrument, wherein an operating part of the instrument is modeled by the simulation, and the user effects deformation of the modeled object by operation of the instrument;
coupled to a haptic user interface device for providing the commands, the haptic user interface device resembling a handle of an instrument, wherein an operating part of the instrument is modeled by the simulation, and the user effects deformation of the modeled object by operation of the instrument, the instrument being for indentation, retraction, grasping, pinching, suction/aspiration, cutting, cauterization, fragmentation, or perforation;
coupled to a haptic user interface device for providing the commands, the haptic user interface device resembling a handle of an instrument at least an operating part of which being modeled by the simulation, wherein the user effects deformation of the modeled object by operation of the instrument, and the enhancement effectively provides an alternative rendering module that takes the model of the instrument, including a position and orientation of the instrument, and the set of states of the elements of the object according to the view, and produces a rendering according to the view; or
coupled to a haptic user interface device for providing the commands, the haptic user interface device resembling a handle of an instrument at least an operating part of which being modeled by the simulation, wherein the user effects deformation of the modeled object by operation of the instrument, and the enhancement effectively supplies to the rendering module a set of states of the elements of the object according to the view modified in that, in a neighborhood of the location of the object where the interaction was applied, a greater number of elements having a different spatial distribution, and states are provided instead of those in the model.

9. The solid mechanics simulation method of claim 1 wherein the simulated object includes a soft mammalian tissue.

10. The solid mechanics simulation method of claim 1 wherein:
the model comprises a volume model and a surface model;
the model comprises a volume element mesh;
the model comprises a finite element method volume element mesh;
the model comprises a surface element mesh;
the model comprises a finite element method surface element mesh;
the model comprises a volume model and a surface model that provides a triangulation map;
the model comprises a volume model and a surface model that provides a triangulation map which is received by the rendering module;
the model comprises a volume model and a surface model that includes a triangulation map of a surface of the object, which is received by the rendering module during regular operation of the simulation;
the model comprises a volume model and a surface model that defines a triangulation map of a surface of the object, which is received by the rendering module, wherein the enhancement receives the triangulation map, and supplies to the rendering a triangulation map that is modified in a neighborhood of the location on the object where the change is effected;
the model comprises a volume model and a surface model that includes a triangulation map of a surface of the object, which is received by the rendering module during regular operation of the simulation, wherein the enhancement receives the triangulation map in a neighborhood of the location on the object where the change is effected, and supplies a triangulation map that is modified in a neighborhood of the location on the object where the change is effected, in accordance with an empirically observed deformation of an actual object represented by the model subject to a similar manipulation;
the model comprises a volume model and a surface model that includes a triangulation map of a surface of the object, which is received by the rendering module, wherein the enhancement receives the triangulation map and renders an image; or
the model comprises a volume model and a surface model that includes a triangulation map of a surface of the object, which is received by the rendering module, wherein the enhancement receives a rendered image, computes a refinement of the rendered image in the neighborhood of the location of the object where the change is effected, and outputs the refined rendering for presentation.

11. The solid mechanics simulation method of claim 1 wherein the rendering enhancement:
comprises an independent model of a local surface of the object in a neighborhood of the deformation;
comprises an independent empirically-based model of a local surface of the object in a neighborhood of the deformation;
is operable contingently;
is operable contingently on a surface map of the model being deemed renderable by a procedure based on the surface map;
is operable contingently on a surface map of the model being deemed renderable by a procedure based on a condition of the model;
is operable contingently on a surface map of the model being deemed renderable by exogenous simulation input;
is operable contingently on an interaction with the model being deemed reversible; or
is operable contingently on a rendered image for presentation on a visual display being deemed smooth.
